(19) United States
(12) Patent Application Publication
(10) Pub. No.: US 2016/0035183 A1
(43) Pub. Date: Feb. 4, 2016

(54) ELECTRONIC GAMING MACHINE SERVICE BUS

(71) Applicant: WMS Gaming Inc., Waukegan, IL (US)

(72) Inventors: DALE BUCHHOLZ, Palatine, IL (US); CRAIG SYLLA, Round Lake, IL (US)

(21) Appl. No.: 14/448,427

(22) Filed: Jul. 31, 2014

(51) Int. Cl. G07F 17/32

(52) U.S. Cl. CPC G07F 17/3225; G07F 17/3244

(57) ABSTRACT

A gaming system includes a modular network services manager (NSM) component which controls communication for network components and network-based services of a gaming machine coupled to an internal communication network coupled to an external communications network. The NSM provides a single external network address for the wagering gaming machine network-based services (e.g., operating system, player interface/overlay graphical user interface, video combining, audio control, printing, touchscreen, bill validation, etc.). The NSM provides internal and external network communications (i.e., internal/external address/port assignment translation), unified network rate adaptation, firewall and security services for internal services, establishment and maintenance of security based session information including certificate retrieval and storage, DHCP services to the internal network-based services, coordinated service discovery, and a helper service to enable an internal service to determine and retrieve the external address and external port number assignment for all available services, including itself.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to a system and method for an electronic gaming machine to actively manage internal devices and service management addressing of the gaming machine and provide secure communication between the electronic gaming machine and remote components of a gaming network.

### BACKGROUND OF THE INVENTION

Gaming machines, such as slot machines, video poker machines and the like, have been a cornerstone of the gaming industry for several years. The ability for gaming machines to connect to a network and view various services of the electronic gaming machine as network-based services would greatly enhance the functionality and expandability of the electronic gaming machines. Therefore, there is a continuing need for gaming machine manufacturers to continuously develop more robust, efficient, and expandable machines, able to seamlessly incorporate and manage additional internal components and networked based services during routine operation, and maintain communicative connectivity between all internal and external computing components.

### SUMMARY OF THE INVENTION

According to one aspect of the present invention, a gaming system is disclosed. The gaming system comprises game-logic circuitry including a controller. The game-logic circuitry is configured to receive an input indicative of a wager to play and present an outcome of a wagering game. The controller is configured to assign one of a pool of internal network addresses to an internal network-service client in response to a request from the internal network-service client for an internal network address. Additionally, the controller is configured to maintain a service entry table. The service entry table contains a plurality of service entries. Each respective service entry includes a service name identifier, an internal network address and internal port number, and, if existent, an external network address and external port number for a corresponding registered network-based service of the gaming system.

According to another aspect of the invention, a computer-implemented method for arbitrating communication between an external network and networked-based services on an internal network of a gaming system is disclosed. The gaming system includes game-logic circuitry configured to receive an input indicative of a wager to play and present an outcome of a wagering game. The method includes assigning, by a controller, one of a pool of internal network addresses to an internal network-service client in response to a request from the internal network-service client for an internal network address. Additionally, the method includes maintaining, by the controller, a service entry table. The service entry table includes a plurality of service entries. Each respective service entry includes a service name identifier, an internal network address and internal port number, and, if existent, an external network address and external port number for a corresponding registered network-based service of the gaming system.

According to one aspect of the present invention, a gaming system is disclosed. The gaming system includes game-logic circuitry including a gaming controller and a secondary controller. The gaming controller is configured to receive an input indicative of a wager to play and present an outcome of a wagering game. The secondary controller is configured to connect and communicate with the gaming controller. The secondary controller is also configured to assign one of a pool of internal network addresses to an internal network-service client in response to a request from the internal network-service client for an internal network address. The secondary controller is also configured to maintain a service entry table. The service entry table includes a plurality of service entries. Each respective service entry includes a service name identifier, an internal network address and internal port number, and, if existent, an external network address and external port number for a corresponding registered network-based service of the gaming system.

According to yet another aspect of the invention, computer readable storage media is encoded with instructions for directing a gaming system to perform the above methods.

According to still another aspect of the invention, the above gaming system is incorporated into a single, free-standing gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a wagering gaming network system according to an embodiment of the present invention.

FIG. 3 is a schematic view of a wagering gaming network system including an electronic game machine with an integrated network service module according to an embodiment of the present invention.

FIG. 4 is a schematic view of a wagering gaming network system including an electronic game machine with a secondary add-on graphical user interface module in addition to an integrated network service module according to an embodiment of the present invention.

FIG. 5A is a flowchart and explanation chart for a process of initialization performed by a network service module (NSM), for example, on reset, restart, or reboot, configuring the NSM to perform DHCP services according to an embodiment of the present invention.

FIG. 5B is a flowchart for the processing of the NSM helper service commands according to an embodiment of the present invention.

FIG. 6A is a flowchart for a process performed by a network service module to perform network address and port translation (NAPT) services on packets received on an internal interface according to an embodiment of the present invention.

FIG. 6B is a flowchart for a process performed by a network service module to perform network address and port translation (NAPT) services on packets received on an external interface according to an embodiment of the present invention.

FIG. 7 is a flowchart for a process performed by a network service module to establish new communication sessions according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

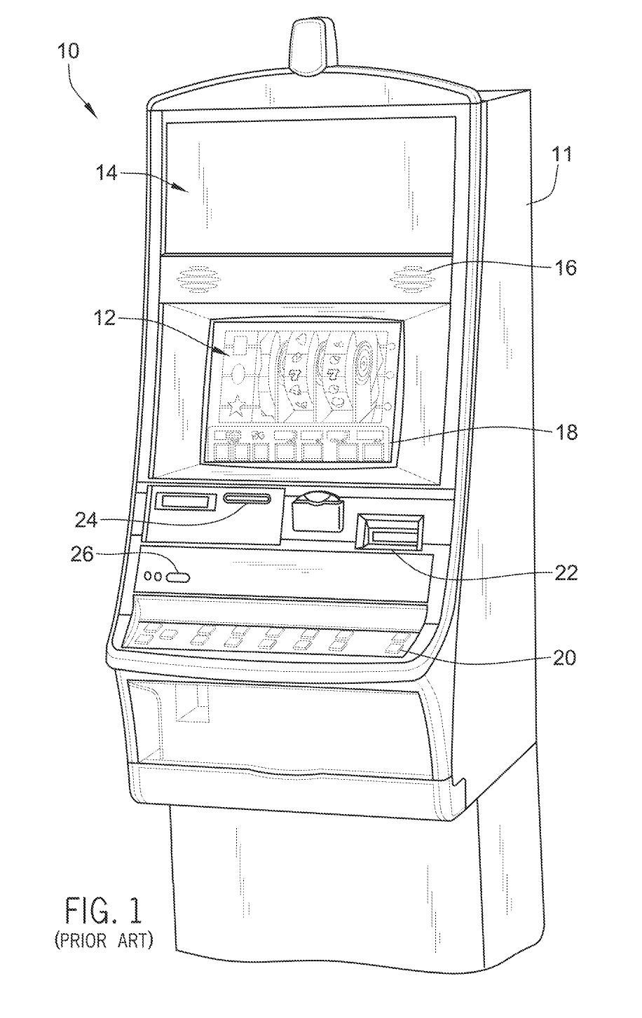

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433, U.S. Pat. No. 8,057,303, and U.S. Pat. No. 8,226,459, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

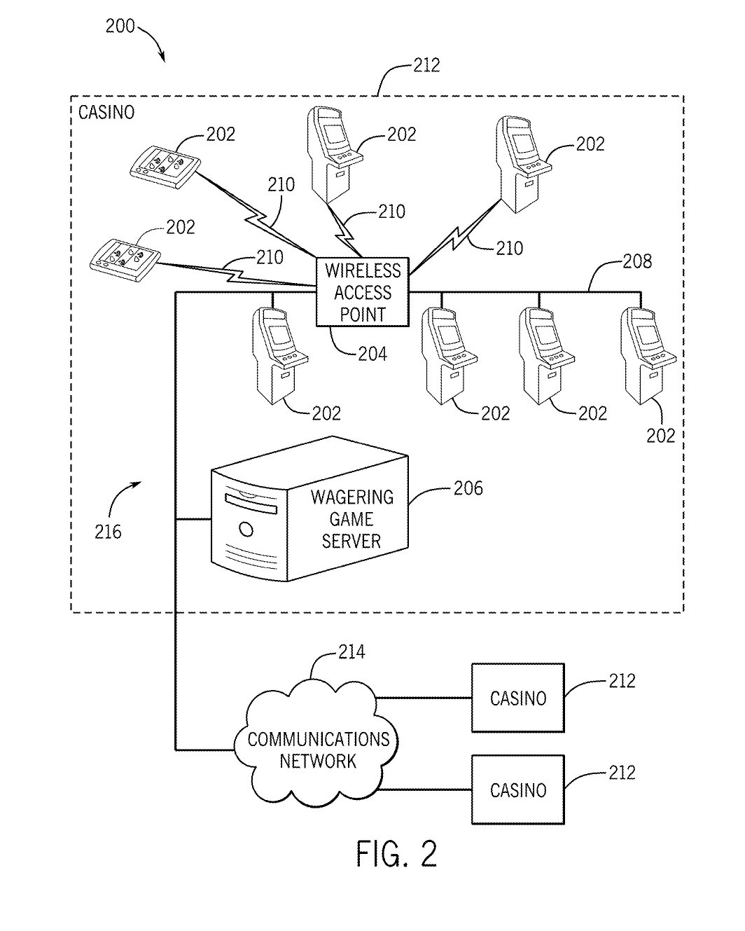

Referring now to FIG. 2, a block diagram is shown illustrating a wagering game network 200, according to example embodiments of the invention. As shown in FIG. 2, the wagering game network 200 includes a plurality of casinos 212 connected to a communications network 214.

Each casino 212 includes a local area network 216, which includes one or more wagering game machines 202, an access point 204, and a wagering gaming server 206. The access point 204 may provide wireless communication links 210 and/or wired communication links 208. The wired and wireless communication links can employ any suitable medium and associated connection technology, such as Bluetooth, IEEE 802.11, Ethernet, public switched telephone networks (PSTN), Synchronous Digital Hierarchy (SDH), Synchronous Optical Networking (SONET), etc. In some embodiments, the wagering gaming server 206 can serve wagering games and distribute content to devices located in other casinos 212 or at other locations on the communications network 214.

The wagering game machines 202 described herein can take any suitable form, such as floor standing models, handheld mobile units, bartop models, workstation-type console models, etc. Further, the wagering game machines 202 can be primarily dedicated for use in conducting wagering games, or can include non-dedicated devices, such as mobile phones, personal digital assistants, personal computers, etc. In one embodiment, the wagering game network 200 can include other network devices, such as accounting servers, wide area progressive servers, player tracking servers, and/or other devices suitable for use in connection with embodiments of the invention.

In some embodiments, the wagering game machines 202 and the wagering game servers 206 work together such that any particular wagering game machine 202 may be operated as a thin, thick, or intermediate client. The specific configuration of the wagering game machine 202 is variable, and dictates how interaction with the network and other network elements will occur. For example, one or more elements of game play may be controlled by the wagering game machine 202 (a network client) or the wagering gaming server 206 (a network server). Game play elements can include executable game code, lookup tables, configuration files, game outcome, audio or visual representations of the game, game assets or the like. In an example having thin-clients, the wagering gaming server 206 can perform functions such as determining game outcome or managing assets, while the wagering game machine 202 can present a graphical representation of such outcome or asset modification to the user (e.g., player). In an example having thick-clients, the wagering game machines 202 can determine game outcomes and communicate the outcomes to the wagering gaming server 206 for recording or managing player accounts. A mix of thin, thick, and intermediate gaming machines are typically present in a casino environment and communicate and operate on the network in various ways.

In some embodiments, either the wagering game machines 202 or the wagering gaming server 206 can provide additional functionality that is not directly related to game play. For example, account transactions and account rules may be managed centrally (e.g., by the wagering gaming server 206) or locally (e.g., by the wagering game machine 202). Other functionality not directly related to game play may include power management, presentation of advertising, software or firmware updates, system quality or security checks, etc.

Any of the wagering game network components (e.g., the wagering game machines 202) can include hardware and/or machine-readable media including instructions for performing the operations described herein. These instructions may be a result of express programming for such functionality imparted to the associated gaming system hardware by transfer or an embedded functional programmatic module, or as a result of the implementation of a physical hardware component imparted with said functional behavior coupled to or otherwise joined with one or more gaming machines, for example, wagering game machines 202.

Each particular piece of computing equipment (such as wagering game machines 202, wireless access point 204, and wagering gaming server 206) on a communication network (such as communication network 214) requires a unique computer network level address to properly route and exchange data on the network. Further, each network device on the network, in addition to having a unique network level address must maintain a set of logical ports in order to simultaneously communicate with other terminals on the network. In computer networking, a port is an application-specific or process-specific logical assignment (i.e., construct) serving as a communications endpoint in a network device's host operating system. While network addresses uniquely identify different network devices, ports uniquely identify different applications or processes running on a single network device. This enables the computers to share a single physical connection, having a single network address, to communicate with other terminals on a packet-switched communication network. A port is identified using a port number, and is used in combination with the unique network address to communicatively couple two computer processes. That is, a communication session between two network devices is realized by data packets being routed across a communication network from an originating network device to a destination network device having a unique destination network address; data packets may be further routed once reaching the destination network device to a specific process bound to the destination port number.

A network device having a single network address may utilize a range of logical ports (uniquely identified by port number) on the network. Further, a network device which is intermediary to two distinct networks may have distinct network addresses for each network it is connected to. In this case, the network device may be considered to simultaneously provide an entry point to an “internal” network and an exit point to an “external” network. Each of these distinct communication interfaces typically have a distinct network address and associated port number. Thus, a network device of this type uses an “internal network address” for communication on the internal network using associated port numbers to connect to processes on the internal network, and uses an “external network address” for communication on the external network using a different set of associated port numbers to connect to processes on the external network.

In one embodiment, a network services module (NSM) is a secondary or modular component which connects to a gaming machine. The NSM functions as an interface for a set of components and network-based services on an internal network of the gaming machine to communicate with a set of components and network-based services on an external network.

The NSM also creates a map between source and destination network addresses and port combinations, serving to translate data packet headers passing through the NSM using this mapping information for information transport on both internal and external networks. The NSM interfaces with both the internal and external networks, and makes the entirety of the wagering gaming machine appear as having a single IPv4 or IPv6 address to the external network. NSM 301 also operates to manage all internal network addressing and routing of data packets to and from the various devices and services of the wagering game machine.

The NSM is configured to determine the external network address(es) (and port numbers) assigned to the processes, applications, and network-based services of the internal network, as viewed from the external network. These external network addresses and port numbers may be requested by the internal network-based service(s) themselves, and used by the internal processes, components, and services, during routine processing.

The NSM may also automatically generate a pool of internal network addresses which do not interfere or conflict with the external network address of the NSM and the external network addressing space. The pool of addresses (and an associated network address mask) is derived, at least partially, in conjunction with the external network prefix. The NSM may use the network prefix of the external network to create a modified network prefix, and create a pool of addresses (i.e., an address space) using this modified network prefix. This ensures there are no components or network-based services using internal network addresses which may conflict (or overlap) with network addresses being utilized by entities on the external network.

The NSM may also use Dynamic Host Configuration Protocol (DHCP) and act as a DHCP server to internal processes, components, and network-based services by assigning an available internal network address from the generated network address pool to each requesting network client.

The NSM may also perform and coordinate network service discovery by mapping internal and external services to names and network addresses, operating to selectively provide network communication between internal network components/services of the gaming machine and the external network components/services.

The NSM may also provide a variety of security functions, including selective filtering of packets flowing through the NSM using a set of rules, and also act as an end point for secure or encrypted communication channels with external network entities. The NSM may additionally maintain a certificate store and perform certificate processing, thereby actively requesting, authenticating, and storing certificates from local and remote certificate authorities for each secured communicative session.

The NSM may also be configured to control the rate of data flow through the network interface in both directions, controlling data flow to both the internal and external network. For example, the NSM may be configured to provide 1 Gb/s to the internal network and provide 100 Mb/s to the external network.

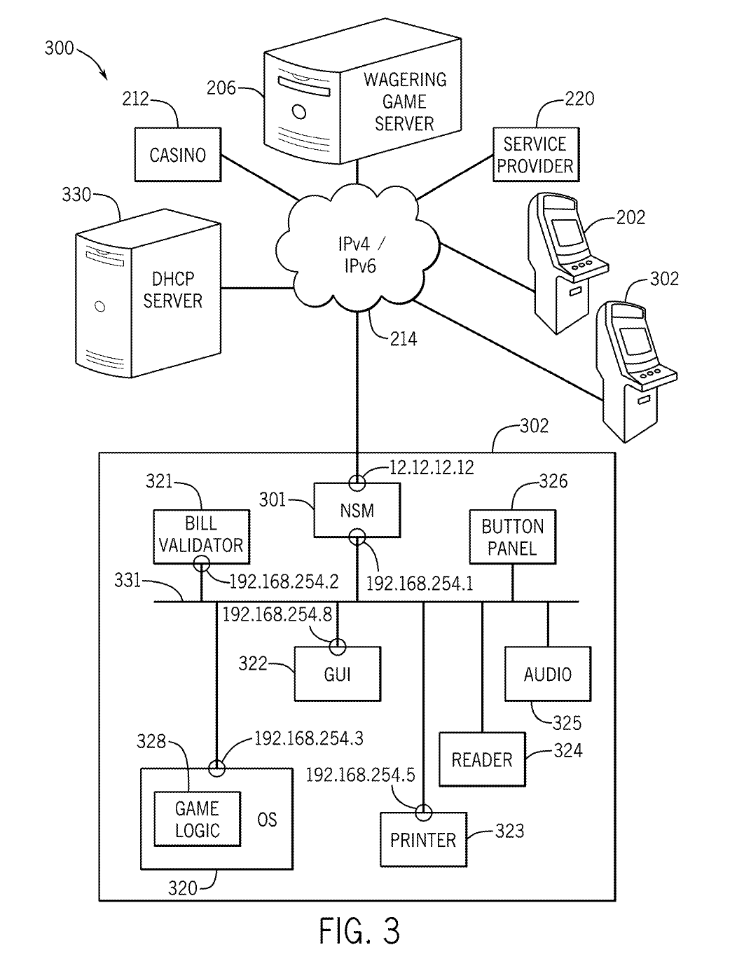

Referring to FIG. 3, a wagering gaming system 300 is shown including a wagering game machine 302 having various internal components which may be accessed as network-based services using the network services module (NSM) 301. The wagering game machine 302 includes an operating system 320, a bill validator 321, a graphical user interface 322, a printer 323, a card reader 324, an audio subsystem 325, and a button panel 326, all coupled by a communication bus 331. The operating system 320 executes digitally stored instructions which perform the wagering game logic 328 for the wagering game machine 302. Each of the services of the wagering game machine 302 has an internal network address. It is possible that a single address may be shared among multiple services. As detailed prior, available services may be instantiated as a process or virtual machine on a shared processor, and/or a process or virtual machine on an independent processor, for example, on a separate board.

The wagering game machine 302 is connected to a communication network 214 which conforms to an Internet Protocol networking addressing space, such as IPv4 or IPv6. The communication network 214 may be connected to a number of wagering game machines which may be configured in a variety of ways, including wagering game machine 202, wagering game machines 302, and other network clients, not individually shown, for example, network clients connected to one or more casinos 212. A wagering gaming server 206 may also be connected to the communication network 214 providing wagering gaming services as outlined prior.

Additionally, a service provider 220 is connected to communication network 214 which may provide a wide variety of network based services to various wagering gaming systems; the service provider 220 generally provides access to one or more specific services for requesting clients on the network. These specific services may be located throughout the wagering gaming system 300, and the network based services that reside on network servers are not limited to location and may reside on any accessible section or segment of the communication network 214. Logical service elements may reside in one or more of a number of different physical devices as part of delivering any requested service. For example, a service provider server 220 may reside in a slot accounting or player tracking system which may be on a local area network collocated with the network clients it services, or manage a large number of local area networks and associated clients from a geographically remote location. Some network based services may be integrated into one or more wagering game machines 202, 302 connected to the communication network 214. One way to achieve this functionality is to couple or bind a process or virtual machine executing on a shared processor, and/or a process or virtual machine executing on an independent processor, to the internal network of the wagering gaming machine 202, 302, thereby becoming part of the wagering gaming system 300 as a whole.

In one embodiment, the NSM 301 operates as an intermediary for various network services both present in a wagering game machine 302 when requested from external clients, and present on the external network when requested by a process on the wagering game machine 302. A listing of a set of core operational services may include one or more of the following services, which may exist as a part of, or external to, a given wagering game machine 302, in one or more embodiments of the invention:
Boot Service—provides dynamic IP addressing to devices upon boot (start-up). This may be supported by the Dynamic Host Configuration Protocol (DHCP).
Discovery Service—provides address information of the server containing a given service when requested by a client as well as the service description, binding, and location on the server.
Authentication Service—accesses a given (or master) authentication database, serving to authenticate the service user (client) prior to allowing the use of services in the wagering gaming system 300.
Authorization Service—accesses a given (or master) authorization database, serving to authorize the use of services in the wagering gaming system 300 for a service user (client).
Gaming Management Service—configures and monitors gaming devices and other services from a central location on the communications network 214.
Helper Service—reports to each internal service upon registration an assigned external network address and port number for the service, and maintains a list of registered internal services.
Name Service—translates names into a suitable network address for a service (name resolution). In some embodiments the name service is implemented using the Domain Naming System (DNS) protocol.
Time Service—globally synchronizes time for devices in the gaming network. This may be implemented by running the Network Time Protocol (NTP) client software on gaming devices.

In addition to the core services described above, some embodiments of the invention include one or more of the following additional services which may exist as a part of, or external to, a given wagering game machine 302:
Accounting Service—provides logging of transaction records for billing and general tracking purposes.
Event Management Service—logs events occurring at client and server devices.
Game Software Update Service—provides dynamic distribution of new or updated game content to gaming devices.
Message Director Service—facilitates the reliable exchange of data messages among multiple application processes within one or more gaming systems using a software-configurable message routing application.
Content Integrity Service—provides the ability to verify the integrity of software components running in the gaming network. This includes the verification of software versions running on gaming devices, peripherals, and services as well the detection of tampering or modification of the software.
Progressive Service—provides functionality for a gaming device to participate within a single progressive jackpot or multiple progressive jackpots.
Player Tracking Service—provides the operator and player with standard player tracking applications such as monitoring card in/card out transactions to track play and award player points for play, providing targeted promotional compensation to specific players, publishing account status to the player or operator, providing temporary gaming machine locking in order to hold the machine for the player for short periods of time, and providing operators and players an interface and capability for Responsible Gaming Initiatives.
Personalization Service—provides the gaming player with a more personalized gaming environment. Examples include a player choosing to see text in Chinese, reminding a player of dinner reservation time, customizing gaming machine graphics, or contributing a portion of his coin in to a football club progressive jackpot.
Cashless Transaction Service—provides the ability for a player to transfer funds between financial institutions, in-house accounts, and gaming machines.
Bonusing Service—provides the ability for casinos to set up bonus games for a specific gaming machine, a carousel of gaming machines, or one or more game themes.
Advertising Service—allows an operator to display advertising information to players in multimedia format as well as simple audio and graphic formats.

As mentioned, any or all of these services are not limited to location and may consist of logical service elements residing in one or more physical devices, including a remote gaming server 206, a service provider 220, or wagering game machines 302, accessible through NSM 301. Further, the list of services is not exhaustive, and may include a number of additional internal and/or external services which are not specifically described.

In one embodiment, each logical component providing network-based service(s) for the wagering game machine 302 in FIG. 3 is an internally located, physically distinct and modular component. For example, each independent component may be a separate system circuit board which couples to connect to the wagering game machine 302 via a common data bus, for example, the communication bus 331, which may include one or more of a universal serial bus (USB) connection, a Peripheral Component Interconnect (PCI) connection/interface, a Peripheral Component Interconnect Express (PCIe) connection/interface, an Ethernet (IEEE 802.3) connection, etc. In one embodiment, the operating system 320 performs all the wagering game logic of the wagering game machine 302. The NSM 301 and the graphical user interface 322 are implemented on physically distinct computing equipment boards coupled to a common internal bus of the wagering game machine 302 having access to various operating system resources, including random access memory and video buffers. Other services may include components having hardware and/or software which is not specifically shown in FIG. 3. These differences in configuration which are recognized as logically and/or functionally equivalent by one skilled in the art should not be considered to limit the invention in any way; any and all of these variations do not depart from the overall spirit and scope of the invention.

The NSM 301 interfaces the wagering gaming machine 302 and its internal components and network-based services with an external network by translating data packet headers for packet transport over both networks using derived mapping information. The interface created by the NSM 301 makes the wagering gaming machine 302 appear as having a single IPv4 or IPv6 address to entities on the external network. Further, the NSM 301 manages all internal network addressing and data packet routing to the various devices and services of the wagering game machine 302.

In one embodiment, the NSM 301 is also equipped to obtain an address for itself on the external network, either through manual entry by an administrator or retrieval of address assignment information from an external Dynamic Host Configuration Protocol (DHCP) server 330. DHCP is a widely used mechanism for dynamically assigning IP addresses when components, devices, or services request a unique identity on a network using a DHCP server (available in both IPv4 and IPv6), as known in the art. When external network DHCP server(s) are used, this may require some additional configuration of the NSM 301 to include a DHCPv4 client, a DHCPv6 client, and/or a stateless address auto-configuration (SLAAC) process specifically enabling an IPv6 host to configure automatically when connecting to an IPv6 network.

In one embodiment, the NSM 301 provides network address translation (NAT) services, including network address and port translation and mapping between internal network addresses and ports and external network addresses and ports. In one embodiment, the NSM 301 is configured to use NAT64 which is a mechanism that enables IPv6 hosts to communicate with IPv4 servers by converting IPv6 packet headers to IPv4 packet headers, and vice versa. A NAT64 server internal to the NSM 301 acts as an endpoint for at least one IPv4 address and an IPv6 network segment of 22-bits. An IPv6 client embeds the IPv4 address it wishes to communicate with using these bits, enabling packets to be sent to the resulting address. The NAT64 server then creates a NAT-mapping between the IPv6 and the IPv4 address, allowing the devices at these addresses to communicate through the NSM 301 during communication sessions. This mapping provides a direct correlation between internal IPv4 addresses (and ports) to external IPv6 addresses (and ports), as well as correlating internal IPv6 addresses (and ports) to external IPv4 addresses (and ports).

In one embodiment, the NSM 301 provides a specific type of network address and port translation (NAPT), a mapping between internal addresses (and ports) to a single external network address (and associated port range). Generally, networks using IPv4 addressing schemes implement NAPTv4, and networks using IPv6 addressing schemes implement NAPTv6. This enables the NSM 301 to map and translate addresses and ports of internal devices with a single external network address and a corresponding set (typically a range) of port numbers when identical address spaces are being used on both sides of the NSM 301 (i.e., internally and externally). This further allows a link-local IPv6 address (internally) to be mapped to a global unicast IPv6 address (externally). NAPTv4 provides IPv4 mapping of internal addresses and ports to external network addresses and ports of IPv4 network addressed nodes; NAPTv6 provides IPv6 mapping of internal addresses and ports to external network addresses and ports of IPv6 network addressed nodes.

NAT64 converts an IPv6 packet into an IPv4 packet and vice versa. For example, when an IPv6 address space is used on an external network 214 and an IPv4 address space is used on an internal network 331, packets received by the NSM 301 from the external IPv6 network 214 are converted to IPv4 packets for forwarding on the IPv4 internal network 331 while packets received from the internal IPv4 network 331 are converted to IPv6 packets for forwarding on the IPv6 external network 214. NAT64 maps an IPv6 address and port to an IPv4 address and port as part of the conversion process.

It is noted there is a significant difference between the use and implementation of NAT64 and the use of NAPTv4/NAPTv6, as detailed above. In short, NAT64 acts to convert network packets to another protocol, and NAPT translates, maps, and correlates distinct addresses and ports (of a single protocol type) on differing networks.

TABLE 1 specifies the particular methods employed by the NSM 301 to interact with various types of network interfaces conforming to differing network address spaces of each network as shown below:

TABLE 1

| | | INTERNAL ADDRESS | | |
|---|---|---|---|---|
| | | IPv4 | IPv4 | IPv6 |
| | | Private | Link-Local | Link-Local |
| EXTERNAL | IPv4 | NAPTv4 | NAPTv4 | NAT64 |
| NETWORK | Private | | | |
| ADDRESS | IPv4 | NAPTv4 | NAPTv4 | NAT64 |
| | Public | | | |
| | IPv6 | NAT64 | NAT64 | NAPTv6 |
| | Public | | | |

An external IPv6 address prefix should typically not be used on any internal network link because this would expose internal services to direct access from the external network. Also, if an external IPv6 address prefix is used on internally defined network link(s), the wagering game machine 302 would potentially have multiple IPv6 addresses, violating the single address requirements set forth in the Gaming Standards Association (GSA) protocols. For these reasons, external IPv6 address prefixes are not used on the internal network.

In one embodiment, the NSM 301 may provide network subnet/prefix information to internal network components based upon external network address determinations. That is, the NSM 301 may determine which subnet or network prefix to use internally on the network (defining the internal network address space) to avoid potential address conflicts with external network addresses (the external network address space). In this embodiment, while using IPv4, the NSM 301 acts as an IPv4 router and a DHCPv4 server; during use of IPv6, the NSM 301 acts as an IPv6 router and a DHCPv6 server.

The NSM 301 is able to detect and provide external IPv4 addresses which are of any type including public, private, or link-local. In one embodiment, the NSM 301 only allows private or link-local addresses on the internal network and does not forward packets from the internal network to the external network when the destination address is an internal address. The NSM 301 typically does not forward packets from the external network to the internal network when the destination IP address is an internal IP address; this prevents an external host from accessing internal network-based services directly.

In one embodiment, the NSM 301 also implements a helper service which allows an internal service to learn the external network address and port assigned to it on the external network. This enables an internal service to communicate its network address and port number(s) directly to an external service, e.g., File Transfer Protocol (FTP) or Game to System (G2S), greatly improving performance and speed of routing and protocol handling when data packet traffic transitions to and from the internal network. The NSM helper service may also be used by internal services to advertise availability of the service to internal and/or external hosts.

The NSM helper service typically runs on an internal processor of the NSM 301, but may be located anywhere local to the wagering gaming machine 302 as a distinct or virtual process or a physically separate modular board executing as an extension to the NSM 301. The NSM helper service will report information from a managed database upon request, enabling other services to know which services are available, and the network address and service port to use to access each service. That is, the NSM helper service registers and maintains distinct service entries for active and available services, including the helper service itself, enabling all services to be aware of the presence of all services.

The NSM helper service registers each internal network-based service for availability and use by internal and external hosts by recording the external network address and service port number of each registered service, along with other information, in a service entry table within a database. That is, the NSM helper service keeps a mapping of each service name to a set of information including the internal and external network addresses and logical ports used for the service, along with other information, in a service entry of a database.

In one embodiment, each service entry may include a service identification or service name (a designator for the internal network-based service), a corresponding internal network address and port number combination for the service, a corresponding external network address and port number combination for the service (if any), an access scope attribute, a security realm attribute, and an expiration timer. The service identification of the internal service may be of any type, including a uniform resource locator (URL) (e.g., http://www.domain1.com or https://www.domain2.com), a domain (e.g., mailserver.edu), a generic service name (e.g., G2Sserver, FTPdataserver), a numerical value, etc.

Each internal service registering with the NSM 301 can also control whether the scope of access is internal only, external only, or both using an access scope attribute. For example, when the access scope attribute indicates the service is internal only, the corresponding external network address and port are not used. This may be designated by setting the external network address to 0.0.0.0 and the external port to 0 (these are not valid address and port values on an IP subnet). When the scope for the service is external only, then the corresponding external network address is set to the network address associated with the external interface of the NSM 301 and the port is assigned by the NSM 301 from an available set of port values. The NSM 301 must be acting as a network switch (physical or virtual) in order to enforce the external only scope, since internal network hosts on the same network subnet do not require a router when forwarding packets. When the scope attribute indicates the service access includes both internal and external access capability, then both internal and external hosts can access the service.

An internal service can also designate the security realm (or realms) to which it belongs. This may be used to determine which security certificates are used for client and server authentication when establishing secure communication sessions. For example, an internal G2S service may require the use of a G2S certificate when negotiating an underlying Transport Layer Security (TLS) or Secure Sockets Layer (SSL) session. A requesting G2S network client must present a valid G2S certificate to the internal G2S service and the internal G2S service must present a valid G2S certificate to the requesting G2S network client. The NSM 301 stores information related to a certificate authority (CA), a registration authority (RA), and endpoint G2S certificates for validating received certificates and sending appropriate G2S certificates to other endpoints.

For example, the NSM helper service may maintain a service entry table which includes security realm attributes specifying designators such as “web”, “G2S”, and “PUI” for each service. Each of these security realms has specific requirements, such as Public Key Infrastructure (PKI), X.509v3 certificates (X.509 is an ITU-T standard for PKI specifying amongst other things, standard formats for public key certificates, certificate revocation lists, attribute certificates, and a certification path validation algorithm), TLS version, and a set of cipher suites, which are used or required for use by the service during secure communication sessions. The definition of these security realm attributes and their requirements is outside the scope of this invention; however, it should be obvious to those skilled in the art that any security realm and its requirements for communicative sessions can be defined and used with the current invention without departing from the scope and spirit of the invention.

The NSM helper service listens on a well-known internal port for service registration requests from the internal service hosts. The well-known internal port for the helper service may be statically configured by embedding it in the NSM 301 (and internal service host software), manually assigned via an administrative interface, or distributed via DHCP as a standard or proprietary configuration option.

The service entry table contains information typically recorded when the service is registered with the helper service of the NSM 301. In one embodiment, this may occur subsequent to a DHCP network address assignment. For example, if the service is a web server running on a distinct board of the wagering gaming machine 302, the board may use DHCP to request an internal network address from the NSM 301. Once an internal network address is obtained, the web server board may send a set registration (SETREG) request to the NSM helper service to register the service information with the NSM 301, (e.g., www.xyz.com, at 192.168.255.10, using service port 80).

A SETREG request contains at least the service name, an internal service host network address and port number, an access scope attribute, and a security realm attribute (if any). The NSM helper service receives the SETREG request, checks the service entry table for a corresponding service entry, adds a new service entry if one is not found, assigns an external network address and port number if required, adds the access scope and security realm attributes, and restarts the expiration timer. When the NSM helper adds a new entry or updates an existing one, it responds with a Registration Status (REGSTAT) message that has a non-zero timer value. The timer value may indicate a duration for which the registration is required to be renewed in order for the registration to remain valid. In most cases, a SETREG request message will cause a REGSTAT response message to be generated, specifically indicating a result of the SETREG request processing, including any additional information generated or determined as part of the response.

For example, in response to a SETREG request, the NSM 301 may determine or assign an external network address and port number to the requesting service (e.g., 140.192.10.10, using port 2106). The NSM 301 records the data in the proper service entry of the service entry table and may respond with a specific type of REGSTAT response message, a set registration acknowledgement (SETREGACK). The SETREGACK is returned to the internal service acknowledging completion of the request and includes the external network address and external port of the internal service. This informs the internal service about the external network address and port number combination which can be used by the internal service during service operation. This information may also be sent by the internal service or NSM 301 to external clients or hosts if required, for example, as part of a G2S or FTP transaction or information exchange.

When the NSM helper service rejects a SETREG request, the NSM helper service responds with a REGSTAT message that has a zero (0) timer value. Alternatively, the NSM helper service may respond with a specialized REGSTAT message, a set registration not acknowledged (SETREGNAK) message. The requesting internal service may retry a SETREG request message if it does not receive a REGSTAT message in a timely manner or if the internal service receives a REGSTAT message or SETREGNAK message indicating a time out or rejection has occurred.

The NSM helper service may broadcast the REGSTAT message using an internal subnet broadcast address (e.g., 192.168.254.255) in order to simultaneously inform all internal hosts of the status of an internal service. The content of the REGSTAT message typically includes timer value information which may indicate that the service is available when the specified timer value is greater than zero and the service is no longer available when the timer value equals zero.

The NSM helper service may receive a delete registration (DELREG) message from an internal service whenever the internal service wants to make its service unavailable to the rest of the internal and/or external subnet. A DELREG message contains at least the internal service name/identification, the internal service host network address, and the internal service port number. When the NSM helper service receives the DELREG message, the NSM helper service checks the table for a matching service identification service entry, deletes the service entry, and responds with a REGSTAT message having a timer value of zero. If the NSM helper service cannot find a service entry in the table which matches the internal service designated in the request message, the NSM may send a REGSTAT response message containing the internal service name/identification and the internal network address/port number combination received in the DELREG message, along with a timer value of zero indicating the specified service entry is not currently registered. The internal service may retry sending a DELREG message if no REGSTAT message is received in a timely manner or when a REGSTAT message is received which indicates the specified internal service has not been timed out or deleted.

Any internal host may request service entry table information related to available internal services from the NSM helper service by sending a get registration (GETREG) message. In response, the NSM helper service may return a REGSTAT message including the entire service entry table. Alternatively, the NSM helper service may send a REGSTAT message for each individual row (i.e., service name/identification) registered in the service entry table. The REGSTAT message is preferably sent only to the requesting internal host (i.e., not broadcast on the internal network) in order to limit the amount of message processing at other internal hosts. However, broadcasting the REGSTAT message on the internal network is possible, if desired, providing up-to-date service entry table information maintenance at all internal hosts. The internal host may retry a GETREG message if it does not receive a complete service entry table in a timely manner.

The REGSTAT response message may contain information indicating whether it: (1) contains a single row from the service entry table as part of a SETREG-REGSTAT exchange for establishing a new service table entry or updating a current service table entry; (2) contains a single row from the service entry table as part of a DELREG-REGSTAT exchange for making a service unavailable; or (3) contains a single row, multiple rows, no rows, or all rows, from the service entry table as part of a GETREG-REGSTAT exchange for retrieving service availability.

The NSM helper service may advertise its availability by having its own row in the service entry table. For example, the service name/identification may be set to “NSM”, the internal service host network address could be 192.168.254.1, and an associated internal port number for the NSM helper service (the port number could be well-known (designated specifically for the NSM helper service) or a port number chosen from the ephemeral/private port range, e.g., 49152 to 65535), the access scope attribute would indicate internal scope only, and the security realm attribute would be optional. A non-zero timer value would indicate that the NSM helper service is currently available. As the timer approaches zero, the NSM helper service could broadcast a REGSTAT message for the NSM helper service with a new large timer value. This serves as a heartbeat or keep-alive mechanism so that internal service hosts know that the NSM helper service is still available. Alternatively, the heartbeat or keep-alive function could be implemented as separate protocol messages, e.g., a “keepalive” message sent out by the NSM helper service to each service, or in response to internal service requests.

Similarly, an internal service can provide a heartbeat or keep-alive message by periodically sending a SETREG message before the NSM helper service timer associated with the internal service times out. In response, the NSM helper service would reset (adjust) the timer to a default or negotiated value for the service upon successfully updating the associated table service entry row. If the timer reset value is negotiated, then the timer value proposed by the internal service would be included in the SETREG message. For example, each internal service may be forced to issue a SETREG message a minimum of once every four or eight hour interval to maintain the corresponding row of the service entry table.

Consider the following as an example of a NSM helper service in one embodiment, having a corresponding service entry table as it relates to the gaming system of FIG. 3:

TABLE 2

| | Internal | Internal | External | External | | | |
|---|---|---|---|---|---|---|---|
| Service Name/ | Network | Port | Network | Port | Access | Security | |
| Service ID | Address | Number | Address | Number | Scope | Realm | Timer |
| NSM helper | 192.168.254.1 | 50000 | | | Internal | | 60 |
| service | | | | | | | |
| www.BV.com | 192.168.254.2 | 443 | 12.12.12.12 | 443 | Both | Web | 60 |
| www.PR.com | 192.168.254.5 | 443 | 12.12.12.12 | 443 | Both | Web | 30 |
| G2Sserver | 192.168.254.3 | 8080 | 12.12.12.12 | 443 | External | G2S | 25 |
| FTPdata | 192.168.254.3 | 50001 | 12.12.12.12 | 60000 | External | Web | 12 |
| GUIserver | 192.168.254.8 | 80 | 12.12.12.12 | 80 | External | PUI | 45 |

In this example, the first row of the service entry table specifies information related to the NSM helper service. The first column of the service entry for the NSM helper service specifies a corresponding name of the service (i.e., service identification). Alternatively, this value may be purely numerical, specifying the service by an arbitrary or assigned numerical value. The following two columns of the service entry indicate the internal network address and internal port number, respectively, corresponding to the addressing of the NSM helper service on the internal network/interface of the NSM 301 (i.e., the communication bus 331). Each service entry also contains the external network address and the external port number, respectively, corresponding to the external network addressing of the service on the external network interface of the NSM 301 (i.e., the communication network 214). It is noted that the external network address and port number fields of the service entry for the NSM helper service do not have values, although they could alternatively be set to 0.0.0.0 and 0, respectively. This indicates the NSM helper service is available solely only on the internal network. This fact is further reflected by the service entry value of the access scope attribute, specifying the NSM helper service runs only on the internal network. The security realm attribute for the NSM helper service is also not set, indicating all internal communications are presumed to be on the same (internal) network (e.g., within the same physical cabinet/enclosure), therefore, adding processing overhead of secure protocols (e.g., security certificates or session encryption) is not required. When the communications between internal hosts are deemed to require secure protocols, the security realm attribute would be set accordingly. The final column of the service entry table specifies a timer value indicating a corresponding expiration of the service entry. If the default timer value is sixty (minutes), the timer value indicates that the NSM helper service is newly available or has just been refreshed. When a timer expires (i.e., value reaches zero), the corresponding service entry may be removed from the service entry table entirely, becoming deregistered by the helper service. This helps to maintain the service entry table with only those service entries which are verified as responsive and functional.

The second and third rows of the service entry table shown in Table 2 contain services that are on different internal hosts but use the same port number, i.e., port 443. When communication is performed between an internal client and an internal service, the internal network address in the packet acts as a differentiator between “www.BV.com” and “www.PR.com” for the two services. When communication is performed between an external client and an internal service, the service name itself acts as the differentiator and the NAPT or NAT64 function is forced to use information in the application data area of the packets to differentiate between the two services to effectively route packets accordingly. For example, port number 443 is a common port number used for Hypertext Transfer Protocol Secure (HTTPS), a communications protocol for secure communication over a computer network. The NSM 301 NAPT or NAT64 function is able to inspect the HTTP request and/or packet headers for a domain name or URL for which the HTTP request is intended. When the NSM 301 recognizes the text “www.BV.com” in the application data of the packets, this causes NSM 301 to substitute the internal network address “192.168.254.2” for the incoming destination network address specified in the packet header. Similarly, recognizing “www.PR.com” causes substitution of “192.168.254.5” for the incoming destination network address of the packets. This enables the NSM 301 to provide differentiation of services (and routing of packetized traffic) that utilize the same external network address and port number.

The fourth, fifth, and sixth row of the service entry table shown in Table 2 demonstrate standard remapping of internal and external network addresses and port numbers; as packets pass through the NSM 301. As data packets are received at the internal and external network interfaces, the data packet headers are suitably modified to contain the intended source and destination network address and port number corresponding to the forwarded network.

The specified timer values for each service entry vary per row based on when the service was made available and when the service entry was last renewed. The owner of each service is responsible for maintaining the availability of that service and the associated timer for that service is maintained using the NSM helper service protocol as described above.

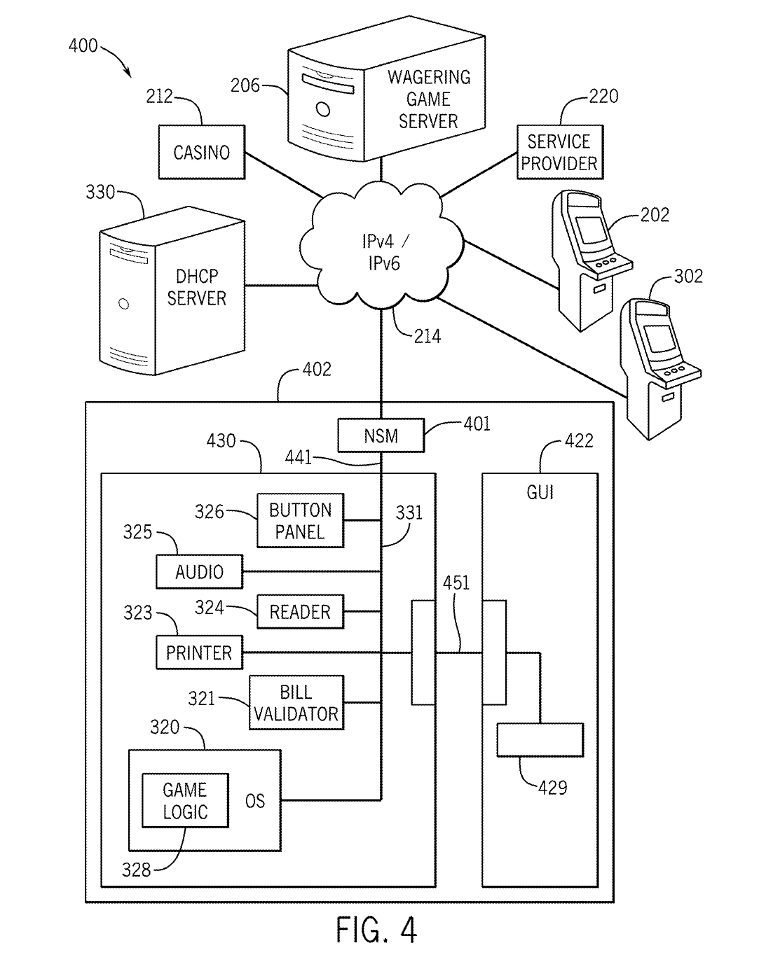

Referring to FIG. 4, an embodiment is shown having a wagering game machine 402 connected to a communication network 214 which conforms to an Internet Protocol networking address space, such as IPv4 or IPv6. The communication network 214 may be connected to a number of wagering game machines which may be configured in a variety of ways, including wagering game machine 202, wagering game machine 302, wagering game machine 402, and other network clients, not individually shown, for example, network clients connected to one or more casinos 212. A wagering gaming server 206 and a service provider 220 may also be connected to the communication network 214 providing wagering gaming services as outlined prior.

The wagering game machine 402 has various internal components which may be accessed as network-based services using a network services module (NSM) 401. The wagering game machine 402 includes a primary wagering game machine 430 having operating system 320, a bill validator 321, a printer 323, a card reader 324, an audio subsystem 325, and a button panel 326, all coupled by a communication bus 331, similar to the wagering game machine 302 of FIG. 3. The operating system 320 executes digitally stored instructions which perform the wagering game logic 328 for the wagering game machine 402. Each of the internal services of the wagering game machine 402 has an internal network address. It is possible that a single address may be shared among multiple services. As detailed prior, available services may be instantiated as a process or virtual machine on a shared processor, or a process or virtual machine on an independent processor, for example, located on a separate board.

In this embodiment, the NSM 401 is an add-on module for the primary wagering game machine 430 communicatively coupled to the communication bus 331 via a communication bus 441. The communication bus 441 may be any type of digital data communication coupling, including but not limited to universal serial bus (USB) cabling, FireWire (IEEE 1394), Ethernet, and/or optical fiber, but may also be realized by direct connection to the communication bus 331 including Peripheral Component Interconnect (PCI), Peripheral Component Interconnect Express (PCIe), etc. Alternatively, the primary wagering game machine 430 may include the NSM 401, either physically within its housing and/or logically by inclusion of its function and performance by the one or more central processing unit(s) executing the operating system 320.

The graphical user interface (GUI) module 422 is an additional add-on module for the primary wagering game machine 430, communicatively coupled to the communication bus 331 via the communication bus 451. Similar to the communication bus 331 and the communication bus 441, the communication bus 451 may communicate via any digital coupling connection type, including USB, PCI, PCIe, etc. The GUI module 422 also has a central processor unit 429 which operates independently from the processing unit(s) of the primary wagering game machine 430, and may run its own native operating system while interfacing with and transferring data between the primary gaming machine 430.

In one embodiment, the GUI module 422 is configured to perform a number of different actions including providing a modified player user interface to a user/player of the wagering game machine 402. The GUI module 422 may also be used to manipulate audio and video presentation(s), map and route player input from multiple input devices to one or more gaming processes, and/or provide secondary game logic.

The GUI module 422 may enable a number of varying services which are available to the wagering game machine 402, and potentially to other network entities as well. As long as each provided service is uniquely identifiable and is network-based, each service provided by the GUI module 422 may be independently accessed, requested, and provided to a requesting client. Further, a number of other services may be made available to the wagering game machine 402 (and other network entities at large), by the coupling of service hardware/software modules to the wagering game machine 402. As stated prior, this includes functional software/hardware modules instantiated as a process or virtual machine on a shared processor, or a process or virtual machine on an independent processor, for example, located on a separate board.

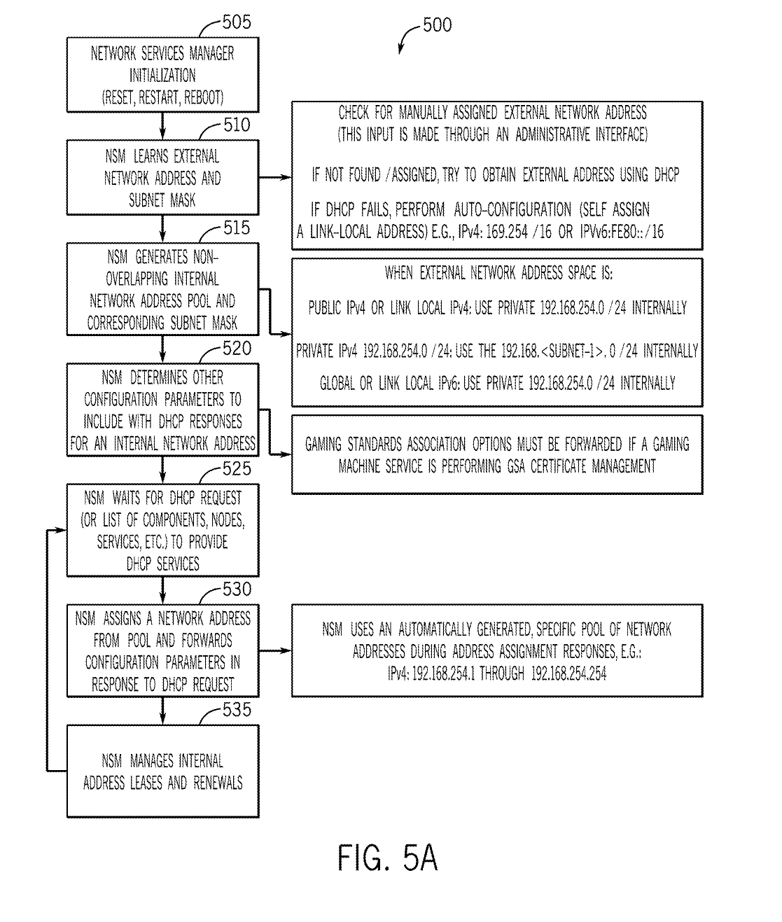

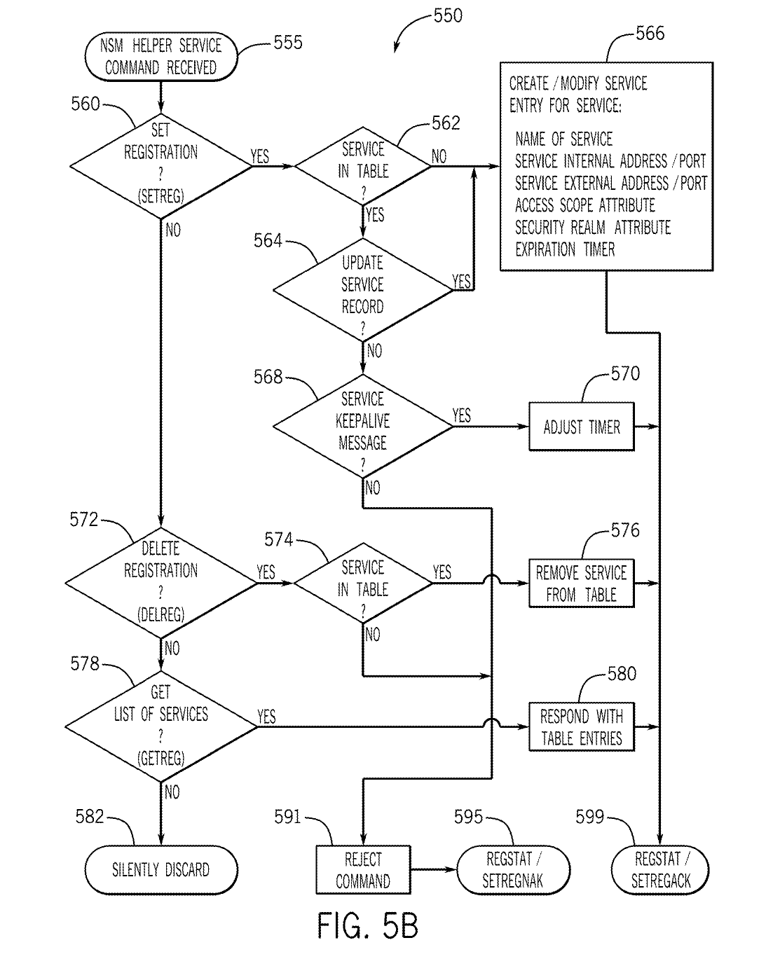

FIG. 5A describes a flow chart of a network address management process 500 in one embodiment which the NSM 301 and the NSM 401 may perform upon startup. That is, on reset, restart, or reboot, the NSM 301 or the NSM 401 performs the described address management process 500 to initialize and begin routine operation to achieve specific intended functions of address assignment, service provision, security, traffic filtering, etc.

In step 505, the address management process 500 begins with the initialization of the NSM 401. The NSM 401 initializes upon resetting, restarting, or rebooting to ready itself for continuous operation. This may include the loading or instantiation of memory modules with programmatic instructions, and/or the preparation of the NSM 401 as a whole to begin a process of routine operation. Additionally, all tables, data structures, databases, etc., associated with NAPT, NAT64, and the NSM helper service, are cleared.

In step 510, the NSM 401 determines a network address and subnet mask for the NSM 401 interface on the external network. The external network address may be from the unicast public or private address space. In the event that the NSM 401 has a statically assigned network address on the external network, the network address of the NSM 401 is manually provided (input) by an administrator via an administrative interface. If no static network address is assigned, the NSM 401 either obtains an external network address using DHCP, or performs auto-configuration to determine the external network address. That is, the NSM 401 acts as a DCHP client by requesting an external network address from a remote DHCP server (e.g., DHCP server 330). If successful, the NSM 401 receives an external network IP address using DHCP and assigns it to the external interface. This is the sole network address which all nodes, components, and network-based services of the EGM will use when communicating on the external network. If the DHCP process fails, the NSM 401 will assign itself a link-local network address.

A link-local network address assignment often occurs as a result of an auto-configuration process caused by the inability of the NSM 401 to obtain a DHCP external network address assignment from a network DHCP server. In one embodiment, auto-configuration assigns a link-local IPv4 address having the format 169.254.xxx.xxx (169.254/16), and/or a link-local IPv6 address having a format with the network prefix FE80 (FE80::/16).

In short, the NSM 401 looks for a manually (statically) assigned external network address first, and if none exists, request an external network address using DHCP, and if this fails, the NSM 401 self-assigns a link local address for the external network address interface.

In step 515, the NSM 401 automatically generates a pool of internal network subnet addresses (along with an associated address mask) which do not conflict with or overlap any of the external network addresses which the NSM 401 is aware. This process automatically defines a pool of network addresses (i.e., an address space) containing a set of network addresses which will be assigned to internal requesting network clients and services by the NSM 401. The pool of network addresses (and the associated network address mask) is derived, at least partially, in conjunction with the external network prefix.

By definition, a subnet is a logically visible subdivision of a network address space. All computers that belong to a subnet are addressed with a common, identical, most-significant bit-group in their network address. For example, this results in the logical division of an IP address into two fields, a network prefix (identifying the network) and a host identifier (identifying the host). That is, the host identifier designates a specific host or network interface on the subnet defined by the network prefix.

In IPv4, a network prefix may be characterized by a corresponding subnet mask. This subnet mask, when applied by a logical (bitwise) AND operation to any IP address in the network, yields the network prefix. An IPv4 network mask consists of thirty-two bits, a sequence of ones followed by a block of zeroes—the trailing block of zeroes designates the part of the network address which indicates the host identifier. For example, the 192.168.1.0/24 network prefix has a corresponding network mask 255.255.255.0, and a network address of 192.168.1.54 has a network prefix of 192.168.1, and a host identifier of 54. Thus, when using IPv4, the external network prefix may be easily derived through use of the network mask and the external network address of the NSM 401 to derive the network prefix and the host identifier of all network terminals on the network, including the NSM 401.

Commonly used with IP networks, 192.168.1.0/24 is a network prefix of the IPv4 network starting at 192.168.1.xx, a pre-defined private network space. In this case, twenty-four bits is allocated for the network prefix, and the remaining eight bits are reserved for individual host addressing. The IPv6 address specification 2001:db8::/32 is a network address block with two-hundred ninety-six addresses, having a thirty-two bit network prefix, 2001:0db0.

The defined pool of network addresses (and the associated subnet mask) may be used during DHCP server processes for future assignments of internal network addresses to requesting network-based clients. This process occurs using DHCP when requesting internal network clients and services rely upon the NSM 401 to act as a DHCP server (i.e., provide a DHCP service), and assign internal network addresses to each particular component, node, and/or network based service available on the internal network.

In the event that a public IPv4 or link local IPv4 address space is in use on the external network/subnet, a private address space (e.g., IPv4 192.168.254.0/24) or IPv6 link local subnet address and mask is used on the internal network to define the pool of addresses for future assignments of addresses for requesting clients on the internal network. There will be no addressing conflicts between entities on these two networks, minimally because the external network entities do not share a common network prefix as the internal network entities.

When a private address space (e.g., IPv4 192.168.254.0/24) is in use on the external network/subnet, another (non-overlapping) private address space (e.g., 192.168.<subnet-1>.0/24) or a IPv6 link local subnet address and mask is used on the internal network. That is, a pool of addresses (i.e., a private address space) is selected which does not conflict with or otherwise overlap with the defined network address space in use on the external network. The selection of the private address space may involve the incrementing or decrementing of the external network IPv4 network mask to derive a network mask which describes an address space which is not in use. Alternatively, the network mask may come from a selection from a list of predefined network address spaces or network masks which may be additionally or further manipulated, if required, to derive a resulting address space which does not share (i.e., overlap or conflict with) any network address(es) with any external network entities. For example, this latter process may occur as a result of the external network being an established subnet having a private address space, perhaps a previously defined “internal” network when interfacing with yet another network of “external” computers.

When a global address space or link local IPv6 is in use on the external network/subnet, an IPv4 private address space (e.g., 192.168.254.0/24) or an IPv6 link local subnet address and mask is used on the internal subnet. This guarantees that there is no conflict between, or overlap of, the internal and external address spaces.

In step 520, the NSM 401 now determines a set of additional configuration parameters which may be forwarded to requesting network clients upon request for DHCP services. In some embodiments, specific parameters and options must be forwarded to a requesting client or service if the gaming machine housing the NSM/DHCP service is managing GSA protocols and certificates in order to conform to various regulatory, operational, and protocol requirements.

At this point, the NSM 401 is configured to function as a DHCP server for internal nodes and network-based services (requesting network clients), and will provide DHCP responses, including assigned network addresses and configuration parameters to requesting clients and network-based services upon request.

In step 525, the NSM 401 receives a request for an internal network address from an internal network client, including an internal network-based service. Alternatively, the NSM 401 may be configured to assign network addresses (and configuration parameters, if appropriate) to a predefined list of network-based services and/or internal components coupled to the internal network interface. In such an environment, the network address requests may be replaced with a list of media access control (MAC) addresses, or predetermined designators dictating which components, nodes, and/or services specifically require DHCP internal address assignment.

In step 530, the NSM 401 assigns a suitable network address using DHCP to the corresponding network client. The NSM 401 responds to the client request with the assigned network address and any additional configuration information for that component, node, or service. The NSM 401 assigns internal network addresses to the requesting DHCP clients from an automatically generated pool of network addresses specifically set aside for this process which do not conflict with or overlap any external network address space. For example, when a public IPv4 network address space is used for the external network, the NSM 401 may use IPv4, 192.168.254.0 through 192.168.254.255 as the address pool from which all internal address assignments are made from, where 192.168.254.0 is reserved for the subnet address, 192.168.254.255 is reserved for the subnet broadcast address, 192.168.254.1 is assigned to the NSM 401, and 192.168.254.2 through 192.168.254.254 are assigned to hosts (physical or virtual) on the internal network in response to DHCP address requests.

In step 535, the NSM 401 actively manages leasing and renewal of all previously assigned network addresses while continuously looping control back to step 525 to continue to respond to requests from internal network clients to obtain network addresses on the internal network.

FIG. 5B is a flow chart detailing a high level process 550 which describes some of the various functions of the NSM helper service performed by NSM 301/401.

In step 555, the NSM helper service receives a command from an internal service. These commands may include a wide variety of functions, including registering an internal service with the NSM helper service, updating a service entry in the service entry table, removing a service entry in the service entry table, or retrieving a list of network-based services registered by the NSM helper service.

In step 560, a determination is made as to whether the received command is a SETREG request. As detailed above, SETREG requests allow a service to register with the NSM helper service so that other processes are aware of the service, may access the service, allow the updating of a currently registered service, and notify the NSM helper service that a network-based service is still active.

In step 562, when the received command is a SETREG request, a determination is made as to whether the service specified in the SETREG request has a service entry in the service entry table used by the NSM helper service.

In step 564, if the service specified in the SETREG request does have an entry in the service entry table, a determination is made as to whether the SETREG request is updating a current service entry in the service entry table.

In step 566, if the service specified in the SETREG request does not have a service entry in the service entry table, or the SETREG request is updating a current service entry in the service entry table, the service entry table is created or modified with the parameters and information bundled with the SETREG request. In the event that there is no service entry for the specified service, a service entry is created for the network-based service. This may be performed by creating a new row in the service entry table. In the event that the SETREG request is updating a current service entry in the service entry table, the entries of the service entry are updated to reflect the current state and parameters of the service.

If the modification to the service entry table is successful, a REGSTAT message is generated acknowledging the service entry has been updated (i.e., a specific type of REGSTAT message, a SETREGACK message is generated), and control returns to the process which called the NSM helper process (step 599). Often, the REGSTAT message will include information regarding the SETREG request, reporting not only success of the requested operation, but parameters generated upon completion of the process. Examples of parameters returned with REGSTAT messages may include internal and external network address and port number combinations, timer values for one or more services, and/or other portions of the service entry table.

In step 568, in response to the SETREG request which relates to an entry in the service entry table, but is not a service update request, a determination is made as to whether the SETREG request is a “keepalive” message, informing the NSM helper service that the service is active and running.

In step 570, when it is determined that the SETREG request is a “keepalive” message, the timer variable specified in the service entry table is adjusted as discussed prior to specify when the service entry will expire and be purged from the service entry table. This may include a predetermined value, a negotiated value, or an assigned value included in the SETREG request, specifying how long the helper service will wait before removing the service entry from the service entry table. This enables efficient use of the limited memory of the NSM 301/401, and reduction of the intrinsic overhead of the database management.

When it is determined that the SETREG request relates to a service entry in the service entry table, but is not a service update request or “keepalive” message, the command in the request is rejected in step 591, and a REGSTAT message is generated indicating the SETREG message has been rejected (i.e., a specific type of REGSTAT message, a SETREGNAK message), and control returns with details of the process transaction (step 595).

The generated REGSTAT response message may include only an indication that the process failed, or may return a detailed analysis of the error, problem, or state of the NSM helper service encountered when trying to interpret or process the SETREG request message. One example of an error of this type may include a service entry attempting to update a service record or provide a “keepalive” message for a service which has been removed from the service entry table for lack of activity (elapse of timer or not currently registered).

In step 572, after determining that the received command is not a SETREG request, a determination is made as to whether the command received is a DELREG command, specifying that a service is to be removed from the service entry table.

In step 574, when the command received is determined to be a DELREG command, a determination is made as to whether the specified service in the DELREG command has a service entry in the service entry table of the NSM 301/401. When it is determined that the specified service does not have a service entry in the service entry table, the command in the request is rejected (step 591), and a REGSTAT message is generated and returned with details of the process transaction in step 595. The REGSTAT message may include only an indication that the process failed, or may return a detailed analysis of the error, problem, or state of the NSM helper service encountered when trying to interpret or process the DELREG request.

In step 576, when it is determined that the specified service has a service entry in the service entry table, the service entry is cleared from the service entry table, removing all details of (deregistering) the service from the NSM helper service. A reporting REGSTAT message is then generated returning control to the process which initiated the DELREG request message, providing information regarding completion of the DELREG request along with parameters generated upon completion of the process (step 599).

In step 578, when it is determined that the command is not a DELREG request, a determination is made as to whether the command is a GETREG request, a request message intending to return information regarding one or more services known to the NSM helper service.

The GETREG request command is very useful when used to enable a network-based service internal to the EGM to determine the external network address and port number combination being used to communicate with other nodes and services on the external network. Once this information is known to the internal network-based service, the information may be directly used by the internal service and/or the external process/component to enhance communication and/or provide enhanced layers of security. Further, gathering of internal network address and port information of other services on the internal network/subnet may be used by requesting internal services to greatly enhance functional behavior and efficiency of the EGM and its various components and network-based services of the internal network.

In step 580, when it is determined that the command is a GETREG request, requesting a list of services known to the NSM helper service, the NSM helper service responds with a REGSTAT message including information regarding the known services (step 599). There may be information within the GETREG command which allows advanced query of the service entry table, and the NSM helper service is programmed to respond accordingly with one or more REGSTAT responses having the queried information. These responses may include a variety of message packages, including but not limited to, a single row, multiple rows, no rows, or all rows, from the service entry table, as well as selective portions of the service entry table in accordance with the query made by the GETREG request.

In step 582, in the event that the command is not a GETREG request in step 578, the request command is silently ignored. This indicates that the submitted request command does not conform to any defined functional responses; that is, the request command is unknown, undefined, or malformed, rendering it impossible and improper to determine what request is being made, and so, no response is generated.

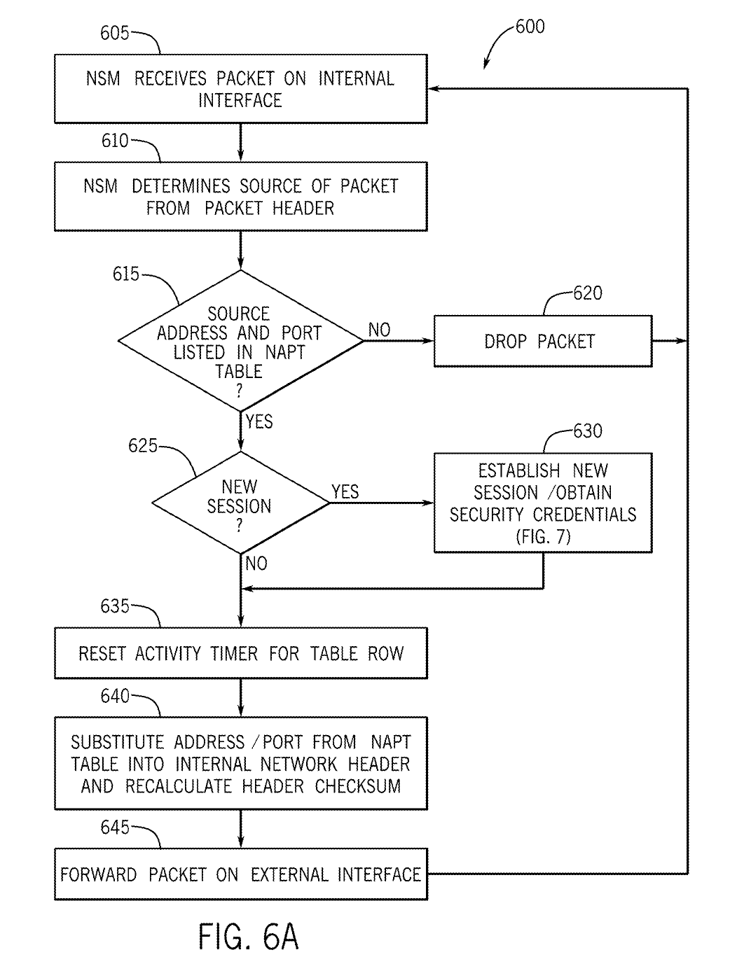

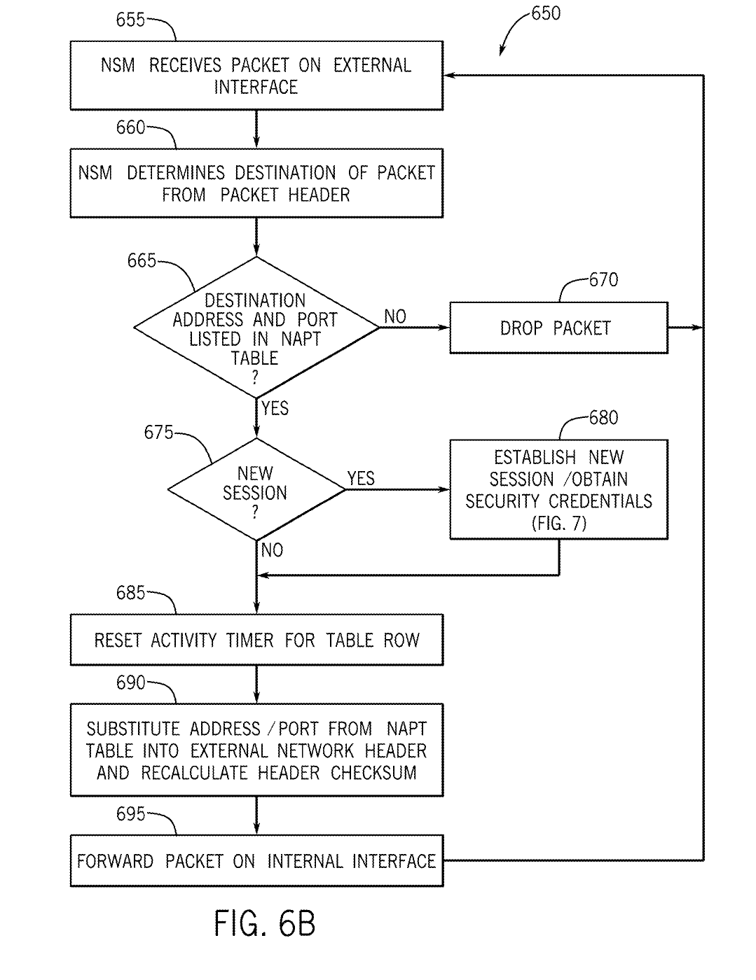

FIG. 6A shows how one embodiment of the NSM 401 performs continuous network address translation (NAT) services for packets received at the internal interface of the NSM 401. When performing NAT service operation 600, the NSM 401 operates to actively manage outgoing data packets which flow through the NSM 401. This is done by translating header information of internal network data packets into header information for external network data packets.

In step 605, the NSM 301/401 receives a packet at the internal network interface.

In step 610, after a packet is received from the internal network, the NSM 301/401 determines the destination of the packet by examining the packet header.

In step 615, the source network address and port number specified in the packet header are analyzed to determine whether the source network address and port number combination is recognized. This may include checking an internally stored table of the NSM 301/401 having entries which correlate session identification numbers or service designations to a source network address and port number combination corresponding to a particular session or service having defined characteristics or parameters.

In step 620, the packet is dropped when it is determined that the received packet originated from a network address and port number combination which does not match an entry in the table stored by the NSM 301/401. Alternatively, the packet may be forwarded or switched to one or more segments of the network, if appropriate, but no processing of the packet and packet header will occur at this time for forwarding to the external network. The NSM 301/401 returns to a state of waiting for packets to be received on the internal interface in step 605.

In step 625, a determination is made as to whether the packet is the initial packet of a new communication session.

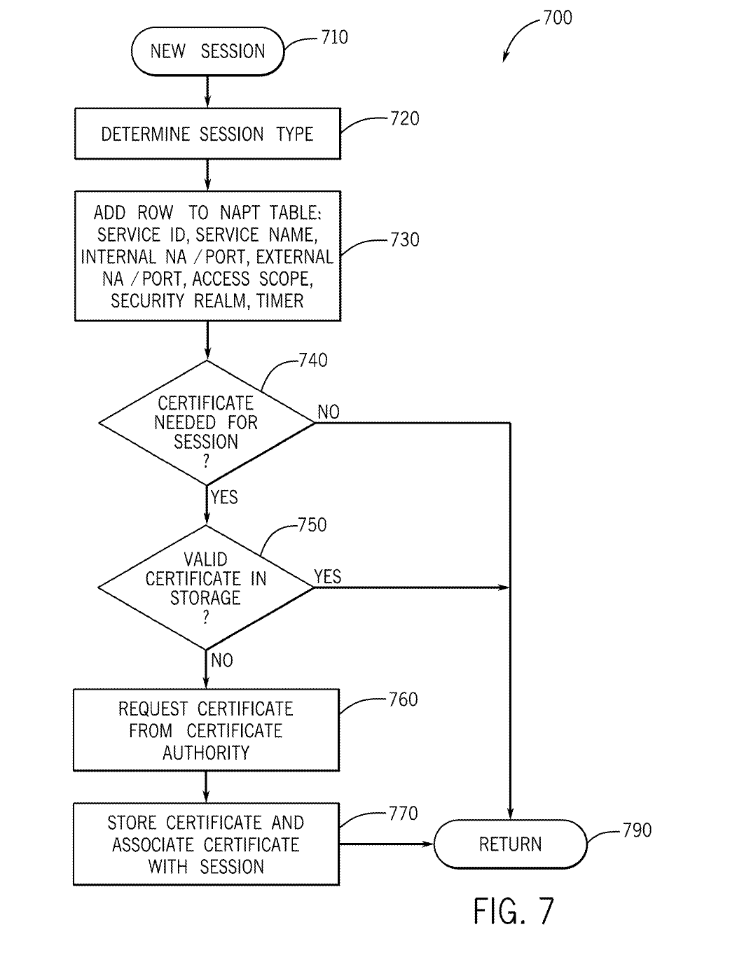

In step 630, when it is determined that a new session is being initiated, the NSM 301/401 must establish the parameters for the new session, and record the information corresponding to the new session for future reference. This process may include determining whether the session requires a security certificate for secure communications and if a valid security certificate exists, etc. This process for establishing a new communication session is fully described below in FIG. 7.

In step 635, when it is determined that the session is not a newly established session in step 625, including sessions initialized and established in step 630, the activity timer for that particular table row is reset (typically to zero). This enables the NSM 301/401 to release (clear) rows of the table after a predetermined period of non-usage, avoiding unnecessary storage of information in the table and inefficient use of limited memory.

In step 640, processing of the packet itself may begin to prepare the packet for transport on the external network. After the activity timer specific to the packet address/port combination is adjusted, the source network address and port number of the node, component, or network-based service are replaced by an external network address (and associated port) of the NSM 301/401 on the external network/subnet. The outgoing packet, after having its header checksum generated and placed in the packet header, is now in a suitable (native) format for the external network and may be routed and switched on the external network with minimal further processing.

In step 645, the NSM 301/401 forwards packets having this “new” “originating” source address present in the packet header directly to the external interface. Once the packet headers have been modified to include the new header information, the packets are native to the external network, complete with proper destination routing (the external network recipient) and return addressing credentials (i.e., network address of the NSM 301/401). Upon communication return, packets received at the NSM 301/401 may be actively forwarded to the internal network through the NSM 301/401 and routed to the proper internal node/process using the NAPT table with minimal processing.

FIG. 6B shows how one embodiment of the NSM 301/401 performs continuous network address translation (NAT) services for packets received at the external interface of the NSM 301/401. When performing NAT service operation 650, the NSM 301/401 operates to actively manage incoming data packets which flow from the external network to the internal network through the NSM 301/401.

In step 655, the NSM 401 receives a packet at the external network interface.

In step 660, after a packet is received from the external network, the NSM 301/401 determines the destination of the packet by examining the packet header.

In step 665, the destination network address and port number specified in the packet header is analyzed to determine whether the destination network address and port number combination is recognized. This may include checking an internally stored table of the NSM 301/401, having entries which correlate session identification numbers or service designations to a destination network address and port number combination corresponding to a particular session or service having defined characteristics or parameters.

In step 670, the packet is dropped when it is determined that the received packet originated from a network address and port number combination which does not match an entry in the table stored by the NSM 301/401. Alternatively, the packet may be forwarded or switched to one or more segments of the network, if appropriate, but no processing of the packet and packet header will occur at this time. The NSM 301/401 returns to a state of waiting for packets to be received on the external interface in step 655.

In step 675, a determination is made as to whether the packet is the initial packet of a new communication session.

In step 680, when it is determined that a new session is being initiated, the NSM 301/401 must establish the parameters of the new session, and record the information corresponding to the new session for future reference. This process may include determining whether the session requires a security certificate for secure communications and if a valid security certificate exists, etc. This process for establishing a new communication session is fully described below in FIG. 7.

In step 685, when it is determined that the session is not a newly established session in step 675, including sessions initialized and established in step 680, the activity timer for that particular table row is reset (typically to zero). This enables the NSM 301/401 to release (clear) rows of the table after a predetermined period of non-usage, avoiding unnecessary storage of information in the table and inefficient use of limited memory.

In step 690, processing of the packet itself may begin to prepare the packet for transport on the external network. After the activity timer specific to the packet network address/port combination is adjusted, the destination network address and port number are replaced by an internal address (and associated port) of the intended node, component, or network-based service on the internal network/subnet. The incoming packet, after having its header checksum generated and placed in the packet header, is now in a suitable format for the internal network and may be routed and switched on the internal network with minimal further processing.

In step 695, the NSM 301/401 forwards packets having this “new” internal destination network address present in the packet header directly to the internal network interface. Once the packet headers have been modified to include the new header information, the packets are native to the internal network, complete with proper destination routing and return addressing credentials.

Referring to FIG. 7, a session initialization and security process 700 is shown for establishing a new communication session through NSM 301/401 in one embodiment.

In one embodiment, the NSM 301/401 also provides various security services, including various PKI Services. These PKI services may include utilizing a certificate store acting to record a certificate/certification authority (CA) (issues and verifies the digital certificates), a registration authority (RA) (verifies the identity of users requesting information from the CA), and any required endpoint certificates. The endpoint certificates may include incoming host certificates, gaming machine-to-system certificates (G2S), and player user interface (PUI) certificates, used for authenticating various components of incoming communications. In one embodiment, the preferred security environment is a public key infrastructure (e.g., conforming to RFC 3280 or RFC 5280) using X.509v3 certificates and TLS. The NSM 301/401 would maintain a certificate storage area for CA, RA, and endpoint certificates using various industry standards, such as Simple Certificate Enrollment Protocol (SCEP), Enrollment over Secure Transport (EST), Certificate Management Protocol (CMP), Online Certificate Status Protocol (OCSP), and certificate revocation lists (CRLs).

The mapping between known session types and required certificate types may be obtained in a number of ways. If an administrator is aware of particular network-based services of the wagering game machine 302/402 and has information about types of sessions between the service(s) along with information regarding an external CA, the administrator may manually input this information in a table stored in memory of the NSM 301/401 specifying certificate type(s) for a particular session type, in addition to one or more authorized CA addresses for obtaining the required certificate(s). Another way information in this table may be determined is through use of a proprietary control protocol implemented between the wagering game machine 302/402 and the NSM 301/401, where specific type(s) of sessions are correlated to certificate types for particular services, which specifically require secure session information transfer.

As mentioned prior, an internal service may designate the security realm or realms to which it belongs, and this information defines the security certificates which will be used for client and server authentication when establishing secure communication sessions. The Security Realm attribute (see Table 2) allows for security certificates and cipher suites to be associated with any communications session.

In step 710, a new incoming or outgoing session is declared. In one embodiment, this occurs in response to step 630 or step 680, where a determination is made that the session information for a packet received by the NSM 301/401 on the internal or external interface is absent from a list of current and known sessions of the NSM 301/401. Thus, a new session is established in response to this absence. This may include the storage of the internal and external network address and corresponding port numbers in one or more tables or databases present in the NSM 301/401.

In step 720, a session type is determined for the new information flow. The NSM 301/401 recognizes and stores various communication session types and may further determine a security certification type of the information flow based upon the specific, determined or assigned, session type. For example, when a G2S session is being established, it may be required that a G2S certificate be obtained from a corresponding, authorized G2S CA. Thus, a session of this type may receive a unique and specialized G2S designation for this session, in addition to other information detailing what G2S CA to use during sessions of this type. Similarly, other secure session types may exist for other communication sessions. For example, the use of the Security Realm attribute may be used to designate parameters for each established session.

In step 730, a row is added to the table being maintained by the NSM 301/401. This may be stored in the network address and port translation (NAPT) table, which may be formatted to include some or all the information outlined prior in regard to Table 2. As mentioned prior, the type of network address and details of the newly established session may be used to ascertain the particular NAPT table, NAPT table entries, and particular NAPT version to implement while processing the packet. The network address translation process which results from the usage of this packet and session data, and immediate source and destination parameter information recognition, significantly improves routing of incoming and outgoing packets during future packet processing.

In step 740, a determination is made as to whether a security certificate is required for the determined session type being established. If not, no certificate for communication is required, and the process ends, returning control to the process detailed in FIG. 6A or 6B (step 790).

In step 750, when a security certificate is required for the type of new session being established, the NSM 301/401 checks to see whether the necessary valid certificates are already in the certificate store to enable secure communications between the end points of the session. If so, there is no need to request another security certificate, and the process ends, returning control to the process detailed in FIG. 6A or 6B (step 790). The client end point may need a CA or RA certificate to validate an incoming certificate from the server, as well as its own certificate to present to the server so that the client can also be authenticated. The security realm attribute definition includes what type of certificates will be used as well as dictating whether authentication will be client and server, or server only.

In step 760, when a required security certificate is not available, the NSM 301/401 requests a valid security certificate from a specified remote CA. This may include the establishment of further communication sessions with the remote CA to specify and retrieve the given digital certificate for secure session communications. Protocols such as SCEP, EST, or CMP may be used for this purpose.

In step 770, once the certificate is retrieved and stored in the certificate store of the NSM 301/401, the certificate is associated with the newly established session.

The process 700 establishing a new session then ends, returning control to the process detailed in FIG. 6A or 6B (step 790).

In one embodiment, the NSM 301/401 is also configured to perform certificate validation (when certificates are received and periodic checks of all certificates in store), certificate enrollment (security key generation, and use of SCEP, EST, and/or CMP to issue and revoke digital certificates), and actively determine certificate status (e.g., using OCSP and/or CRLs).

In one embodiment, the NSM 301/401 is also configured to fully utilize the Internet Protocol Security (IPsec) protocol suite, designed for securing communications by authenticating and encrypting each packet of a communication session. This may occur in either tunnel or transport mode, and inclusion of the Internet Security Association and Key Management Protocol (ISAKMP) and the Internet Key Exchange (IKE) protocol.

In one embodiment, the NSM 301/401 performs a full range of firewall packet filtering, using a variety of differing methods and processes known to those skilled in the art at the time of invention.

In one embodiment, the NSM 301/401 performs Transport Layer Security (TLS), and its predecessor, Secure Sockets Layer (SSL), by using these cryptographic protocols designed to provide communication security over unsecured networks. These processes include the use of cipher suites, a named combination of authentication, encryption, and message authentication code (MAC) algorithms used to negotiate the security settings for a network connection. This may include generation and maintenance of security keys, use of hash and encryption algorithms, for example.

In one embodiment, the NSM 301/401 provides session management, specifically managing particular (or sets of) sessions established between secure network endpoints. This may include mapping of certification type(s) to session type(s), (e.g., G2S certificates for G2S, PUI certificates for PUI, etc.). To this end, the NSM 301/401 may be further configured to request appropriate certificates based on manual input through an administrative interface (e.g., CA address and certificate type), as well as learned information using proprietary control protocols between a gaming machine service and the NSM 301/401), to provide the particular use of certificates for an identified or register session type.

In one embodiment, the NSM 301/401 also provides other network services including IPv4 and IPv6 address caching as a domain name server (DNS) client, provide IPv4 and IPv6 name resolution as a DNS server, Network Time Protocol (NTP) client for synchronizing clocks, coordinating service discovery using Simple Service Discovery Protocol (SSDP), dynamic network interfacing including wired internal to wireless external and interfaces having different rates, and network caching.

In one embodiment, the NSM 301/401 provides a robust G2S service. This includes interacting with external hosts as a G2S client managing G2S transport negotiation, maintaining Simple Object Access Protocol (SOAP) and Hypertext Transfer Protocol Secure (HTTPS) connections to each host, maintaining WebSocket connections to each host, compression/decompression of Extensible Markup Language (XML) to/from Efficient XML Interchange (EXI), and mapping internal control protocols to G2S. The NSM 301/401 may also interact with internal network nodes acting as a proxy G2S from internal devices and services that speak G2S when the operating system of the gaming machine views the NSM 301/401 as a G2S host.

In one embodiment, the NSM 301/401 operates to provide quality of service (QoS) services. When the NSM 301/401 operates as an Ethernet switch, virtual local area networks (VLANs) may be used to segregate traffic, and the use of IEEE 802.1Q header information may be used to provide certain priority to various types of packets using Class of Service (CoS) parameters. When the NSM 301/401 operates as a router, differentiated services code point (DSCP) may be used to manage traffic for differentiated services, as well as configuring the NSM 401 to classify, mark, and/or shape traffic in both directions, from both the internal to external interface, and the external to internal interface.

In one embodiment, the NSM 301/401 is realized on an independent, modular, add-on system board which is connectable to legacy gaming machines and electronic gaming equipment equipped with a suitable interface. Once the NSM 301/401 board is coupled to wagering gaming machine 202/302/402, the NSM 301/401 provides services, including Network Address Translation (NAT) at the wagering gaming machine 202/302/402. This allows the native wagering gaming machine 202/302/402 and any additional add-on components (e.g., a video gaming overlay graphical user interface) and other services of the wagering gaming machine 202/302/402 to share a single network address on the external network and be individually identified, addressed, and subsequently accessed. Further, the NSM 301/401 enables access and addressing to services which are integrated in the future using the same methodology.

In one embodiment, while the wagering gaming machine 202/302/402 services are viewed as network-based services (e.g., operating system, player interface/overlay graphical user interface, video combining, audio control, printing, touchscreen, etc.), the NSM 301/401 is specifically configured to perform at least any combination of the following:
provide a virtual networking environment mapping the external appearance of the network/services (having a single external network level address) to a completely different, non-conflicting, non-overlapping internal network implementation (using a automatically generated pool of network level addresses).
map all internal IPv4 (and/or IPv6) network addresses and port numbers to external IPv4 or IPv6 addresses and port numbers (where some or all services are running on their own board internally linked over Ethernet, for example, operating system and gaming logic executes on one board, graphical user interface on another board, printer queue/control on another board, button panel on another board, etc.).
automate the mapping of internal network addresses and associated port numbers to external network addresses and associated port numbers and provide translation of network traffic between the internal and external address spaces.
manage (i.e., create, update, remove, and retrieve) a plurality of service entries in a service entry table upon request, the service entry table including parameters for all registered services, for example, specifying a service name/identification for the service, a set of internal and external network level addresses and associated port numbers for the service, a set of parameters for scope of network address access and security designations, and a set of timers to ensure each of the services specified in the service entry table are still available and accessible.
enable every process, application, and network-based service registered on the internal gaming system network to determine and use the external network address and port number(s) of all available services, including itself.
be a network traffic rate adapter, controlling the rate of traffic to both internal and external network interfaces (e.g., 1 Gbps Ethernet internal and 100 Mbps external).
operate as a firewall providing security to internal services and components by filtering packet traversal according to a given rule set.
establish, provide, maintain, and act as a terminating end point for secure connections to external network nodes (e.g., TLS or IPSec)
maintain a certificate store by determining security type(s) for each communication session with each service, negotiating, retrieving, authenticating, and storing certificates in accordance with service requirements and the service entry table for secure communications.
generate a pool of internal network addresses (create an internal address space) for internal network-based services and components automatically, which do not conflict with, or overlap any network addresses on the external network.
provide DHCP services for network-based services when such components and services are connected over an internal LAN (e.g., Ethernet) which do not conflict with other network entities.
coordinate service discovery both internally and externally to the electronic gaming machine (e.g., Simple Service Discovery Protocol or DNS), and make such service discovery information available to all authorized services and network clients of the gaming system.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system comprising:
game-logic circuitry configured to receive an input indicative of a wager to play and present an outcome of a wagering game, the game-logic circuitry including a controller configured to:
assign one of a pool of internal network addresses to an internal network-service client in response to a request from the internal network-service client for an internal network address; and
maintain a service entry table comprising a plurality of service entries, each respective service entry including a service name identifier, an internal network address and internal port number, and, if existent, an external network address and external port number for a corresponding registered network-based service of the gaming system.

2. The gaming system of claim 1, wherein, in response to a request from the corresponding registered network-based service of the gaming system, the controller generates a response message including information from the respective service entry of the service entry table.

3. The gaming system of claim 2, wherein the information includes the external network address and external port number for the registered network-based service.

4. The gaming system of claim 1, wherein each respective service entry further includes a security attribute comprising an access scope specifying one or more networks which the corresponding registered network-based service is authorized to communicate over, or a security realm specifying a set of security provisions for a communication session established with the corresponding registered network-based service of the gaming system.

5. The gaming system of claim 4, wherein the controller maintains a certificate store comprising a plurality of security certificate records, each security certificate record including security certificate information for a secure communication session established with the corresponding registered network-based service of the gaming system, based on the security attribute in the respective service entry.

6. The gaming system of claim 1, wherein the controller is configured to determine an external network address for the controller on an external network, and in response, automatically generate the pool of internal network addresses which neither conflicts with, nor overlaps, an external network address space of the external network.

7. The gaming system of claim 6, wherein, in response to determining that the external network is using an external private IPv4 address space, the pool of internal network addresses is automatically generated from an internal private IPv4 address space created by dynamically modifying a network prefix of the external private IPv4 address space.

8. A method for arbitrating communication between an external network and networked-based services on an internal network of a gaming system, the gaming system including game-logic circuitry configured to receive an input indicative of a wager to play and present an outcome of a wagering game, the method comprising:
assigning, by a controller, one of a pool of internal network addresses to an internal network-service client in response to a request from the internal network-service client for an internal network address; and
maintaining, by the controller, a service entry table comprising a plurality of service entries, each respective service entry including a service name identifier, an internal network address and internal port number, and, if existent, an external network address and external port number for a corresponding registered network-based service of the gaming system.

9. The method of claim 8, wherein, in response to a request from the corresponding registered network-based service of the gaming system, the controller generates a response message including information from the respective service entry of the service entry table.

10. The method of claim 9, wherein the information includes the external network address and external port number for the registered network-based service.

11. The method of claim 8, wherein each respective service entry further includes a security attribute comprising an access scope specifying one or more networks which the corresponding registered network-based service is authorized to communicate over, or a security realm specifying a set of security provisions for a communication session established with the corresponding registered network-based service of the gaming system.

12. The method of claim 11, wherein the controller maintains a certificate store comprising a plurality of security certificate records, each security certificate record including security certificate information for a secure communication session established with the corresponding registered network-based service of the gaming system, based on the security attribute in the respective service entry.

13. The method of claim 8, wherein the controller is configured to determine an external network address for the controller on an external network, and in response, automatically generate the pool of internal network addresses which neither conflicts with, nor overlaps, the external network address space of the external network.

14. The method of claim 13, wherein, in response to determining that the external network is using an external private IPv4 address space, the pool of internal network addresses is automatically generated from an internal private IPv4 address space created by dynamically modifying a network prefix of the external private IPv4 address space.

15. A gaming system comprising:
game-logic circuitry including a gaming controller and a secondary controller, the gaming controller configured to receive an input indicative of a wager to play and present an outcome of a wagering game, the secondary controller configured to:
connect and communicate with the gaming controller;
assign one of a pool of internal network addresses to an internal network-service client in response to a request from the internal network-service client for an internal network address; and
maintain a service entry table comprising a plurality of service entries, each respective service entry including a service name identifier, an internal network address and internal port number, and, if existent, an external network address and external port number for a corresponding registered network-based service of the gaming system.

16. The gaming system of claim 15, wherein, in response to a request from the corresponding registered network-based service of the gaming system, the controller generates a response message including the external network address and external port number for the registered network-based service from the respective service entry of the service entry table.

17. The gaming system of claim 15, wherein each respective service entry further includes a security attribute comprising an access scope specifying one or more networks which the corresponding registered network-based service is authorized to communicate over, or a security realm specifying a set of security provisions for a communication session established with the corresponding registered network-based service of the gaming system.

18. The gaming system of claim 17, wherein the controller maintains a certificate store comprising a plurality of security certificate records, each security certificate record including security certificate information for a secure communication session established with the corresponding registered network-based service of the gaming system, based on the security attribute in the respective service entry.

19. The gaming system of claim 15, wherein the controller is configured to determine an external network address for the controller on an external network, and in response, automatically generate the pool of internal network addresses which neither conflicts with, nor overlaps, an external network address space of the external network.

20. The gaming system of claim 19, wherein, in response to determining that the external network is using an external private IPv4 address space, the pool of internal network addresses is automatically generated from an internal private IPv4 address space created by dynamically modifying a network prefix of the external private IPv4 address space.
